(19) United States
(12) Patent Application Publication
(10) Pub. No.: US 2008/0089732 A1
(43) Pub. Date: Apr. 17, 2008

(54) Method and apparatus for a grit-type roller for a printer

(76) Inventor: Ezra Szoke, Fremont, CA (US)

Correspondence Address: Jaison C. John;Williams, Morgan & Amerson, P.C., Suite 1100, 10333 Richmond Ave., Houston, TX, 77042, US

(21) Appl. No.: 11/546,629

(22) Filed: Oct. 12, 2006

(51) Int. Cl. B41J 11/057

(52) U.S. Cl. 400/662

(57) ABSTRACT

An apparatus and system for using a gritty-type roller for performing a printing process, is provided. An apparatus includes a roller for modifying a position of a print medium relative to a print head. The roller includes an exterior lining. The lining includes a plurality of particles for providing traction between the roller and the print medium.

### BACKGROUND OF THE INVENTION

1. Field of the Invention

This invention relates generally to printing and, more particularly, to a method, apparatus and system for implementing a grit-type roller for a printer.

2. Description of the Related Art

There have been various advancements in the area of image and text printing technology. Printing images and/or text includes capturing or generating text and image data and processing them for printing. Generally, images and/or text files are downloaded onto a printer using a computer. Various mechanisms are used to guide a print medium, such as paper, across a receptacle of the printer to register an image or text onto the print medium.

Often, data from a computer or other electronic device is sent to a printer, wherein the data is then used to place an image, text, or both onto the print medium by a printer. State-of-the-art print processes generally use a roller, which may be coated with a material, such as rubber, to guide the paper as it is moved in relation to a print head printing. These rollers may be coated with a rubber material and provides guidance of the print medium by guiding a print medium through the printer. The rubber may be of varying thicknesses and varying durometer ratings.

There are various problems associated with state of the art printing processes. The use of the rubber coated rollers may cause the print medium, such as paper, to slip in a position relative to the roller. This may cause indexing errors when printing with multiple passes through various films. Designers have attempted to address some of these problems. For example, designers have attempted to introduce a greater amount of contact between the roller and the print medium in an attempt to alleviate the slip position problem. This can result in large rollers and additional mechanical considerations.

Other attempts to alleviate problems with the current dye diffusion printer technology include using a high-pinch roller force method. This method involves pinching the print medium using a bottom roller as it is driven through the printer. This method amounts to pulling the paper through the printer, where the roller rotates in a passive manner. The high-pinch roller force can worsen the alignment problem as it is highly dependent on rubber thickness and durometer levels. Additionally, damage to the print medium may occur as a result of large amount force being applied to the print medium. These methods may result in registration problems due to slipping of the paper in relation to the rotation of the roller.

Additionally, as a result of registration errors, multiple passes that may be used in printing process may result in banding and miss-registration problems. Another problem associated with the high-pinch roller forces may include the use of multiple rollers, a narrow roller underneath the paper and a smooth one on top to pinch the paper. This method is used in an attempt to improve dye registration. However, when the print medium is driven in a high pinch force, the rubber roller may experience some movement-tolerance, wherein the print medium may move at least minutely, which may result in registration errors.

The present invention is directed to overcome, or at least reduce, one or more of the problems set forth above.

### SUMMARY OF THE INVENTION

In one aspect of the present invention, an apparatus is provided for using a gritty-type roller for performing a printing process. The apparatus includes a roller for modifying a position of a print medium relative to a print head. The roller includes an exterior lining. The lining includes a plurality of particles for providing traction between the roller and the print medium.

In another aspect of the present invention, an apparatus is provided for using a gritty-type roller for performing a printing process. The apparatus includes a roller for providing a force upon a print medium. The force is used to provide contact between the paper and a film. The roller is also adapted for modifying a position of the print medium relative to a thermal print head. The roller includes an exterior lining. The lining includes a plurality of particles for providing traction between the roller and the print medium.

In yet another aspect of the present invention, a printing device is provided for using a gritty-type roller for performing a printing process. The printing device includes a print head unit for delivering a thermal gradient. The printing device also includes a roller for providing movement of a print medium. The roller also provides a force upon the print medium. The force is used to provide contact between the paper and a film in a direction towards the print head unit for applying the thermal gradient upon the film. The roller includes an exterior lining. The lining includes a plurality of particles for providing traction between the roller and the print medium.

In yet another aspect of the present invention, a system is provided for using a gritty-type roller for performing a printing process. The system includes a data supply unit for providing print data. The system also includes a printing device for printing the print data. The printing device includes a print head unit for delivering a thermal gradient. The printing device also includes a roller for providing movement of a print medium. The roller is also adapted to provide a force upon the print medium. The force is used to provide contact between the paper and a film in a direction towards the print head unit for applying the thermal gradient upon the film. The roller includes an exterior lining. The lining includes a plurality of particles for providing traction between the roller and the print medium.

In yet another aspect of the present invention, an apparatus is provided for using a gritty-type roller for performing a printing process. The apparatus includes a roller for modifying a position of a print medium relative to a print head. The roller includes a plurality of particles on at least a portion of the surface of the roller. The particles provide traction between the roller and the print medium.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a stylized three-dimensional depiction of a thermal printer, in accordance with one embodiment of the present invention;

FIG. 2 illustrates a stylized diagram of a printing system that includes various portions of the printer of FIG. 1, in accordance with one illustrative embodiment of the present invention;

FIG. 3A illustrates a stylized, isometric view of the print roller 110 of FIGS. 1 and 2, in accordance with one illustrative embodiment of the present invention;

FIG. 3B illustrates a stylized, cross-sectional view of the print roller 110 of FIGS. 1 and 2, in accordance with one illustrative embodiment of the present invention;

FIG. 4 depicts a more detailed illustration of a print head unit of FIGS. 1 and 2, in accordance with one illustrative embodiment of the present invention;

FIG. 5 illustrates an implementation of a roller with the particular implementation of the print head of FIG. 4, in accordance with one illustrative embodiment of the present invention;

FIG. 6 depicts a more detailed illustration of a print head unit of FIGS. 1 and 2, in accordance with an alternative illustrative embodiment of the present invention; and

FIG. 7 illustrates an implementation of a roller with the particular implementation of the print head of FIG. 6, in accordance with an alternative illustrative embodiment of the present invention.

While the invention is susceptible to various modifications and alternative forms, specific embodiments thereof have been shown by way of example in the drawings and are herein described in detail. It should be understood however that the description herein of specific embodiments is not intended to limit the invention to the particular forms disclosed, but on the contrary, the intention is to cover all modifications, equivalents and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will, of course, be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Embodiments of the present invention provide for various implementation of a grit-type roller for a printer. A grit-type roller may be used for providing movement and pressure or force for registration of print material onto a print medium in a thermal, ink-injection, and/or a dye diffusion printing process. Embodiments of the present invention provide for novel embodiments of a grit implementation onto a roller to provide desired pressure/force and movement to provide desired accuracy of a print material registration onto a print medium, such as paper. Embodiments of the present invention may provide for a print head with a particular flat area used in conjunction with a roller, such that desired registration between the print head and the flat area provided by the roller may be implemented. Alternatively, embodiments of the present invention may be used to print a concave shaped end of a print head in conjunction with an appropriately shaped print roller to deliver desired accuracy of print registration onto a print medium.

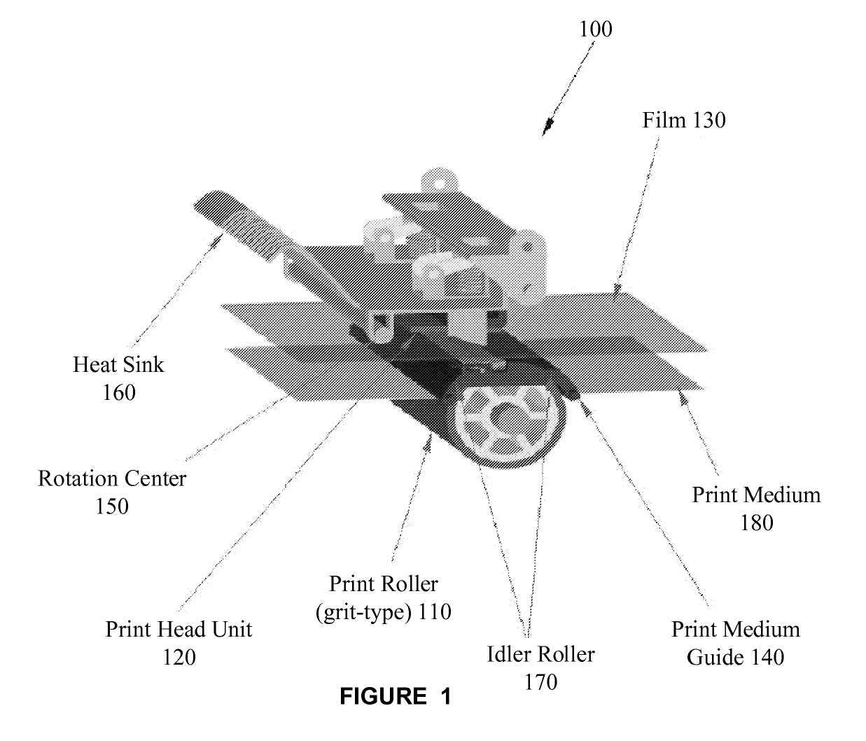

Turning now to FIG. 1, a printer, in accordance with one embodiment of the present invention is illustrated. The printer 100 illustrated in FIG. 1 displays a print medium 180 in a parallel position with a film 130. The print medium 180 illustrated in FIG. 1 may include any one of various printable items such as paper, cardboard, other flexible material, or any other medium capable of receiving print material. FIG. 1 illustrates the print medium 180 being traversed through the printer 100. A print material, such as dye, from the film 130 may be transposed onto the print medium 180. This transposition of the print material may be caused by a force exerted by a print roller 110 that presses the print medium 180 and the film 130 onto a print head unit 120. The print medium 180 may be moved forward and backward through the printer 100 various times with different films 130 in order to transpose various colors onto the print medium 180.

A rotation center 150 provides for facilitating a rotation movement of the roller 110, which causes the paper to traverse through the printer 100. The print roller 110 provides for movement of the print medium 180 along a print medium guide 140. The print medium guide 140 provides assistance to the print roller 110 in traversing the print medium 180 through the printer 100. Additionally, the print roller 110 may provide a force or pressure in causing a contact with the print medium 180 to the film 130, to at least a portion of the print head unit 120. The print head unit 120 provides for delivering heat to appropriate precise locations on the print medium 180 in order to register print material from the film 130 onto the print medium 180.

The print head unit 120 may comprise a plurality of thermal heads (described in subsequent Figures and accompanying description below) to provide for registry of print material from the film 130 onto the print medium 180. The print head unit 120 may comprise a predetermined number of thermal heads spaced at various dots per inch (DPI) configurations. The print head unit 120 may comprise a plurality of thermal heads spaced at a configuration of various dots per inch units, such as the exemplary configurations of 300 DPI, 600 DPI, 900 DPI and a 1200 DPI, 1500 DPI, 1800 DPI, 2400 DPI, 2800 DPI, 3200 DPI, etc. for delivery of print material onto the print medium 180. Those skilled in the art would appreciate that the DPI configurations listed above are for exemplary purposes and not meant as a limitation to the embodiments of the present invention.

The print roller 110 may comprise a silicone material, a ceramic material, etc. The print roller 110 may comprise a lining comprised of various materials, such as rubber. The print roller 110 may also comprise a plurality of particles (i.e., grit) on the rubber to provide for traction. The term “grit” may comprise one or more of a plurality of materials or particles that may be implemented onto the lining of the print roller 110. More detailed description of the grit is provided below.

A heat sink 160 is provided to sink the heat provided by the thermal heads on the print head unit 120. Furthermore, a plurality of idler rollers 170 may provide for rolling and guiding the paper across the printer 100 in conjunction with the print roller 110 in order to provide desirable registry and accuracy of the print material onto the print medium 180. Various electrical signals may be used to control the various thermal heads on the print head. The electrical signal may be used to provide an indication of the amount of time and the temperature involved in delivery of the print material on the film 130 onto the print medium 180.

In one example, a particular print medium 180 may be sent through one or more times through the printer 100 for delivery of print material from various films 130. For example, the print medium 180 may be scanned across the print head unit 110 four times. The first pass of the print medium 180 may involve a yellow film 130. The second pass of the print medium 180 may involve a second time a magneto film. The third pass of the print medium 180 may involve a red film. The fourth pass of the print medium 180 may involve a clear coat film to provide a clear material onto the print medium to enhance the printing results. The amount of force, the amount of heat, and the time period of the force applied to the print head unit 120 may determine the type of print results that may occur. These factors may be controlled electrically to provide control of the print function.

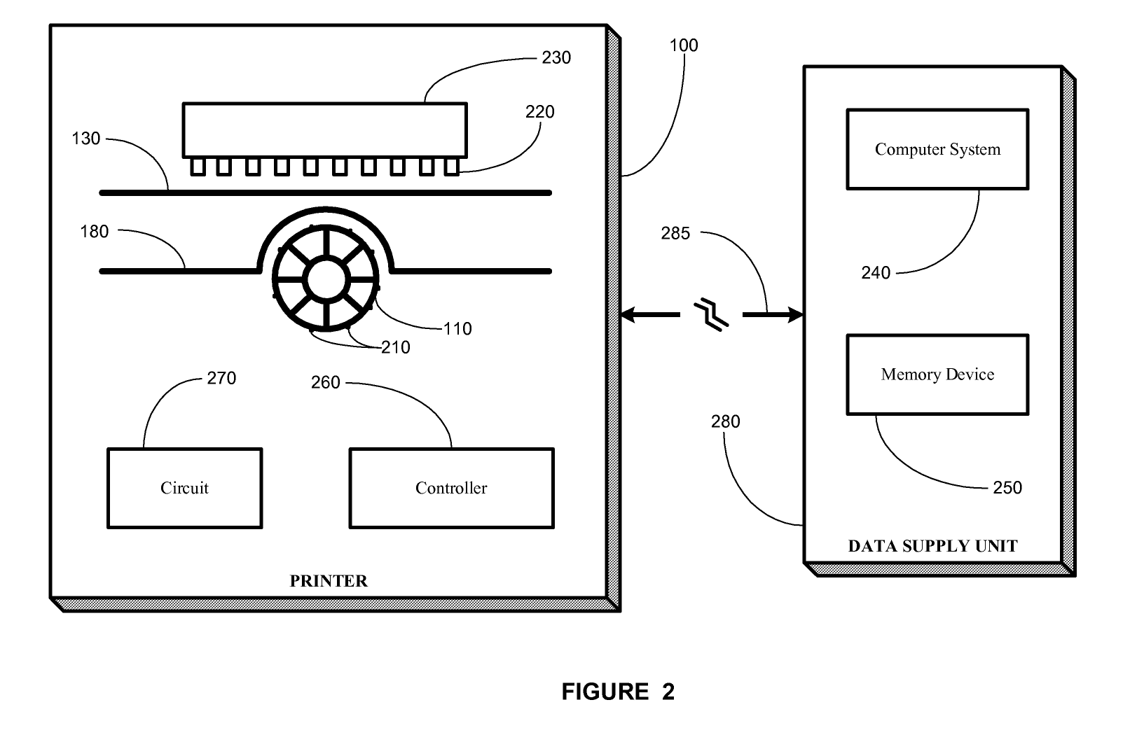

Turning now to FIG. 2, a stylized depiction of a system 200, which includes various components of the printer 110, is illustrated. For clarity of illustration, selected portions of the printer 100 are illustrated. The print head unit 120 and a roller 110 of the printer 100 are illustrated. The printer also comprises a controller 260 capable of controlling various operations of the printer 100. The controller 260 may include processors, memory, and other electronics for facilitating receiving and processing various data signals received by the printer 100. The printer 100 may also comprise a circuit 270 that is capable of receiving electrical signal(s) and providing thermal energy, servo control, and/or other electrical and/or electromechanical operations of the printer 100. The circuit 270 may comprise electrical circuitry to provide for activation and control of the thermal effect provided by the print heads 220.

The system 200 also comprises a data supply unit 280 capable of delivering print content data and/or print command data to the printer 100. In response to the print command data, the controller 260 may execute a printing function based upon the print content provided by the data supply unit 280. The data supply unit 280 may communicate with the printer 100 via a communication line 285. The communication line 285 may be a wired line, such as a network line (e.g., a local area network line [LAN]), a universal serial bus (USB) line, a serial data communication line, a parallel data communication line, a cable communication line, a wireless line, or any type of data communication line.

In one embodiment, the data supply unit 280 may comprise a computer system 240 that is capable of providing print content data and/or print command data to the printer 100. In another embodiment, the data supply unit 280 may comprise a memory device 250 (e.g., a flash memory device, etc.) that is capable of providing print content data to the printer 100. A print function may be initiated by a user by providing a signal to the controller 260 in order to print the print content data. The data supply unit 280 may comprise other electronic devices that may be capable of delivering print content data to the printer 100.

FIG. 2 illustrates a grit material 210 that may be added onto the lining of the roller 110.

In one embodiment, the print head unit 120 comprises a print head receptacle 230 that is capable of receiving and holding a plurality of print heads 220. The print heads 220 may be thermal devices capable of delivering precise thermal energy gradients or thermal areas at various DPI configurations described above. The print head receptacle 230 may comprise components such as a heating element for heating individual print heads 220.

The print heads 220 may be spaced upon a predetermined DPI configuration and are capable of accurate registration of print material from the film 130 onto the paper. The print registration may be made possible by the delivery of precise thermal energy by the print heads 220. The thermal energy is delivered to a specific point on the film 130, which may cause transfer of print material from the film 130 onto the print medium 180.

The grit 210 on the print roller 110 may provide traction against the print medium 180 to provide for desirable movement of the print medium 180, which may result in accuracy of registration of print material onto the print medium 180. In one embodiment, the roller 110 is a cylindrical shaped roller that is capable of rotating to grip the print medium 180 and provide force against the print heads 220 for delivery of print material onto the print medium 180. Embodiments of the present invention provide for a novel combination of the type of grit 220 utilized on the print roller 110, in combination with various shapes for the print heads 220. Additionally, embodiments of the present invention provide for a novel combination of the type of grit 210, such as fine grit, along with the types of surface of the print heads 220, in combination with the diameter of the roller to provide for accuracy in registration of a print material onto the print medium 180. The grit 210 on the roller 110 provide for accurate movement of the print medium 180, which may result in the registration of print material from various films 130 during repeated scanning of the print medium 180 through the printer 100.

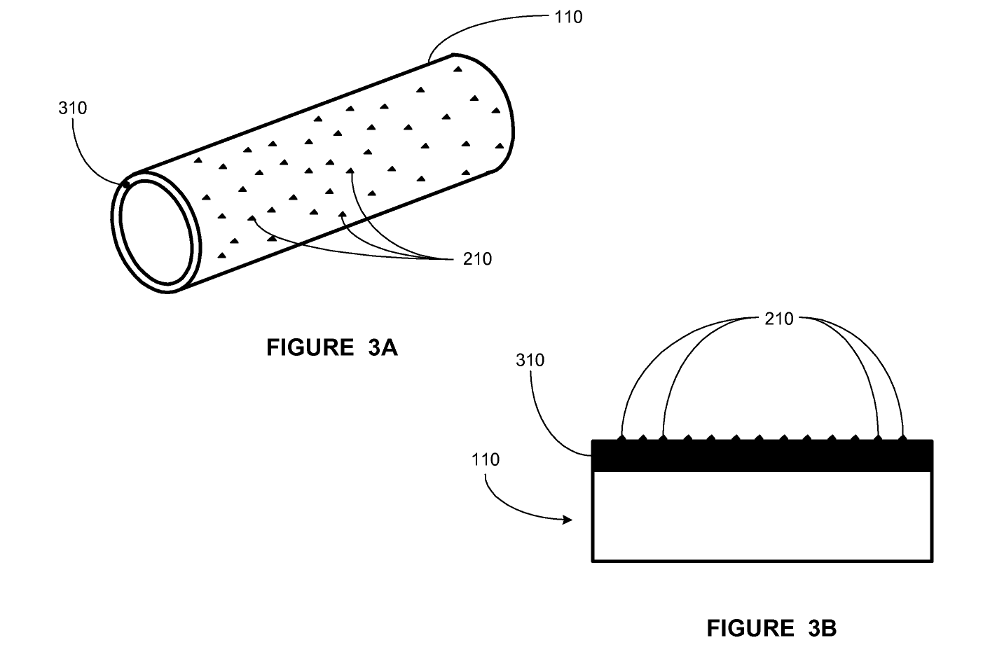

Turning now to FIGS. 3A and 3B, various depictions of the print roller 110, in accordance with embodiments of the present invention is illustrated. FIG. 3A illustrates a stylized, isometric view of the print roller 110, in accordance with one illustrative embodiment of the present invention. FIG. 3B illustrates a stylized, cross-sectional view of the print roller 110, in accordance with one illustrative embodiment of the present invention.

As illustrated in FIG. 3A, the print head 110 may be coated with a lining material 310 that may be made out of various compounds, such as flexible materials e.g., rubber, etc. Various particles or grit 210 may be implemented onto the lining material 310 to provide traction between the print medium 180 and the roller 110 for traversing the print medium 180 through the printer 100. Various manufacturing techniques known to those skilled in the art having benefit of the present disclosure may be used to implement the grit 210 onto the lining material 310. As illustrated in the cross-sectional view in FIG. 3B, the lining material is affixed to the print roller 110. The grit 210 is impailed or implemented onto the lining material 310. The material for the grit 210 may be spaced in a variety of manners, such as any recurring uniform spacing pattern, or in a random fashion.

The grit 210 may be of varying shapes and may have a relatively smooth or coarse surface. The number of grits 210 may be determined by a plurality of factors, such as the type of print medium 180 to be used, the type of film 130 to be utilized, and/or various other factors. The grit 210 may be implemented onto the lining material 310 in such a fashion that it may resemble sand paper. In one embodiment, the size of the grit 210 may be a fraction of the print medium 180, such as approximately 1/10^{th} of the thickness of the print medium 180. In some embodiments, the grit material may be 0.0003 inches. Those skilled in the art having benefit of the present disclosure would appreciate that a variety of patterns, sizes and shapes for the grit 210 may be utilized and remain within the scope and spirit of the present invention. In one embodiment, the grit 210 may provide for a fine grit implementation onto the lining material 310 of the print roller 110. The fine grit implementation of the print roller 110 may present an effectively smooth surface between the paper print medium 180 and the print head 220 at the point of contact. In one embodiment, the fine grit implementation of the present invention provides for desirable accuracy in the registration of the print material onto the print medium and improvements is various operations of the printer 100.

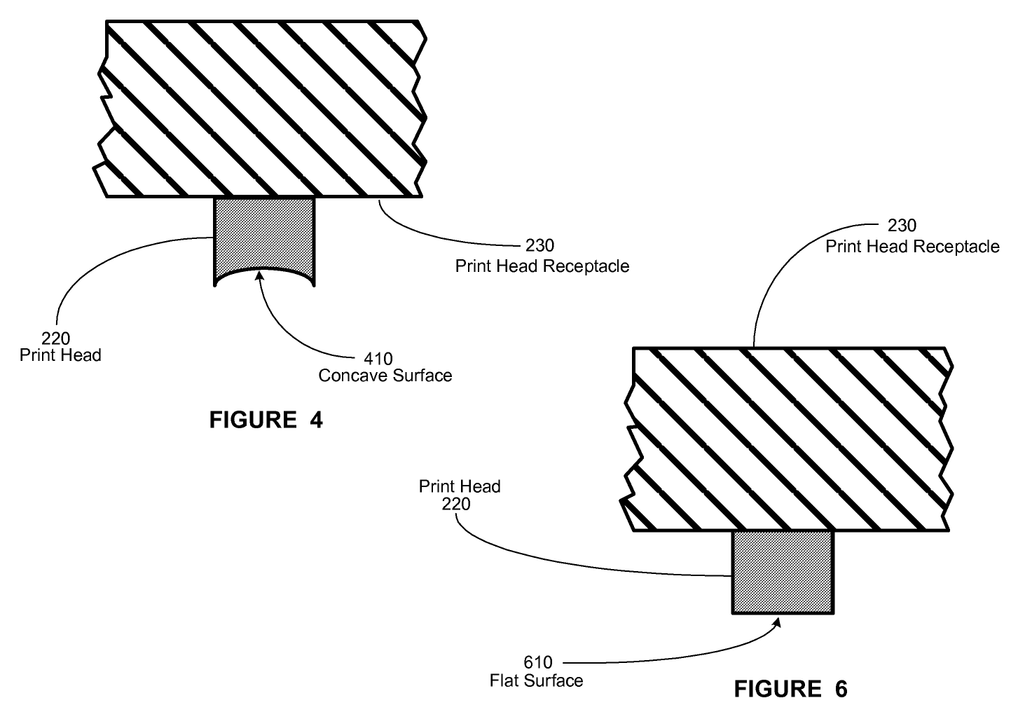

Turning now to FIG. 4, a stylized depiction of one embodiment of the print head unit 120 is illustrated. As illustrated in FIG. 4, the print head receptacle 230 may be attached to the print head 220, which may comprise a concave type surface 410. The concave surface 410 is capable of directing thermal energy substantially even throughout the area along surface 410. The concave surface 410 may be capable of delivering thermal energy unto the film 130 for transferring printing material onto the print medium 180.

The use of the fine grit and the concave shape surface 410 of the print head 220, in relation with the print roller 110 provides for a geometry that provide for desirable accuracy in the registration of the print material onto the print medium 180. Referring simultaneously to FIGS. 4 and 5, the concave shape of the surface 410 of the print head 220, in conjunction with a predetermined curvature of the print roller 110 provides for predetermined accuracy in the registration of the material from the film 130 onto the print medium 180. As illustrated in FIGS. 4 and 5, the surface 410 print head 220 is shaped in a concave manner such that the curvature of the print roller 110 corresponds to the curvature of the concave surface 410, such that materials from the film 130 are accurately transferred onto the print medium 180. The geometry of the surface 410 of the print head 220 and the print roller 110 provides for an area 510 that provide for a precision intersection of the print head 220, the film 130, the print medium 180, and the print roller 110. The film 130 and the print medium 180 experience a substantially uniform thermal distribution in the area 510. Those skilled in the art having benefit of the present disclosure would appreciate that the illustration in FIGS. 4-7 is not drawn to scale. The illustrations in FIG. 4-7 have been drawn to illustrate that the print heads 220 may be designed to conform to the geometry of the print roller 110.

The area 510 provides for delivery of uniform thermal energy to the film 130, which provides for precision transfer of print material from the film 130 onto the print medium 180. This precision transfer of print materials may also be enhanced as a result of the print medium 180 being accurately pulled through the printer 100 using the grit-type roller 110. Therefore, the grit-type roller 110 is designed in such a shape to match the various print head surface shapes 410 such that from effectively a flat surface is provided at the intersection of the film, the print medium 180, the print head 220, and a portion of the print roller 110. Thereby, the embodiment provided by FIGS. 4 and 5 provides for desirable accuracy of the registration of the print material onto the print medium 180.

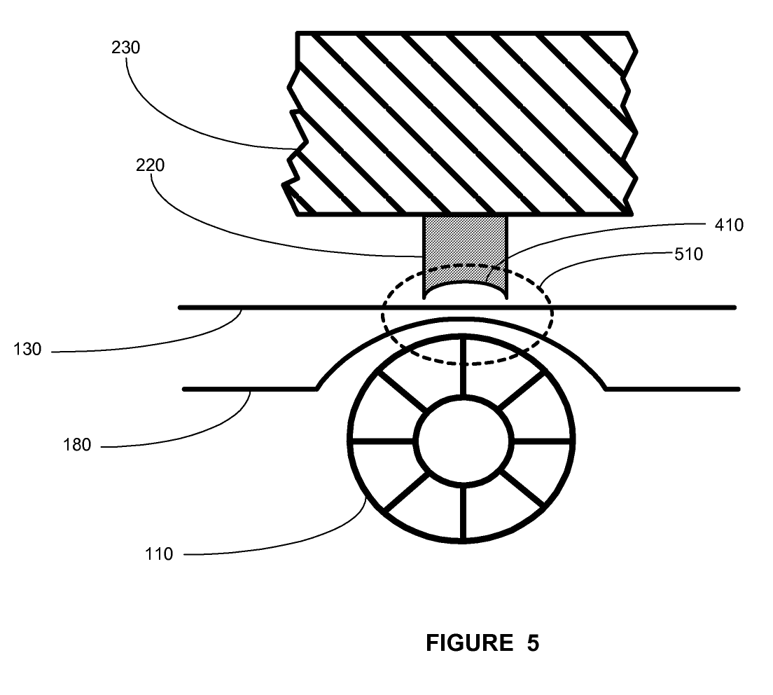

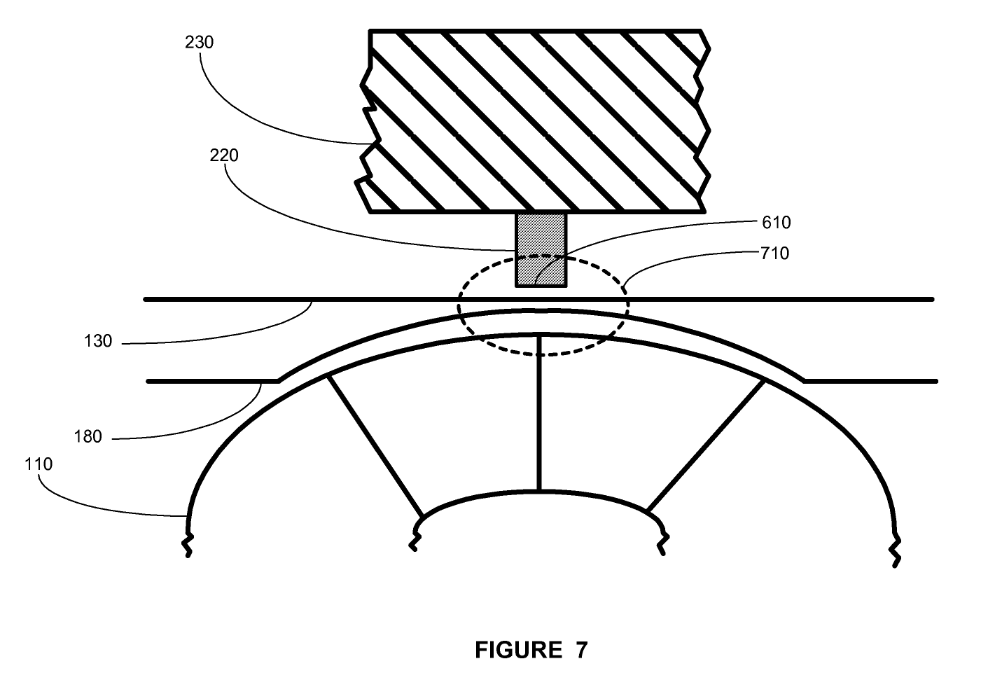

Turning now to FIG. 6, an alternative embodiment of the print head 220 in the print head unit 120 is provided. As illustrated in FIG. 6, the print head receptacle 230 may be attached to the print head 220, which may comprise a flat surface 410. The flat surface 410 is capable of directing thermal energy substantially even throughout the area along surface 410. The flat surface 410 may be capable of delivering thermal energy onto the film 130 for transferring printing material onto the print medium 180.

Referring simultaneously to FIG. 6 and FIG. 7, an implementation of the flat surface 610 in conjunction with a grit roller 110 is illustrated. In the alternative embodiment presented by FIGS. 6 and 7, the interface between the print head 220, the film 130, the print medium 180, and a portion of the print roller 110 provides for a substantially flat area for accurate registration of the print material from the film 130 onto the print medium 180. The flat surface 420 provides for accurate registration of thermal energy onto the film and onto the print medium 180. As illustrated in FIGS. 6 and 7, the surface 410 print head 220 is shaped in a flat manner such that a portion of the curvature of the print roller 110 corresponds to the flat surface 610 of the concave surface 410 such that materials from the film 130 are accurately transferred onto the print medium 180. The geometry of the surface 410 of the print head 220 and the print roller 110 provides for an area 710 that provides for a precision intersection of the print head 220, the film 130, the print medium 180, and the print roller 110. The film 130 and the print medium 180 experience a substantially uniform thermal distribution in the area 710.

The grit type roller 110 provides for accurate movement of the print medium 180 when the shape of the roller 110 is such that at the point of intersection, encircled by the circle label 710, a relatively flat area is available for thermal distribution. The flat area in the circle 710 of the portion of the roller 110 interfaces in a relatively flat manner with the flat surface 410 of the print head 220, thereby delivering a substantially uniform distribution of thermal energy onto the film 130 for transfer of printing medium.

Utilizing the various embodiments provided herein, accurate movement of the print medium 180 through the printer 110 is provided using the grit-type roller in conjunction with the fine grit and the shapes of the print heads surfaces described above along with a predetermined diameter of the rollers 110. Accurate registration of print material from the film 130 onto the print medium 180 is provided. The embodiment illustrated in FIG. 7 may call for a larger print roller, as compared to the embodiment illustrated in FIG. 5. Embodiments of the present invention may also be implemented in various other types of printers that provide for movement of the print material through an area of print material delivery.

A variety of communication protocols may be implemented for the operation of the printer described herein. The embodiments of the present invention may be utilized with a variety of data sources as well as a variety of different types of printers in order to obtain accurate registration of print content.

The particular embodiments disclosed above are illustrative only as the invention may be modified and practiced in different but equivalent manners apparent to those skilled in the art who have the benefit of the teachings herein. Further, no limitations are intended to the details of construction or design herein shown other than as described in the claims below. It is therefore evident that the particular embodiments disclosed above may be altered or modified and all such variations are considered within the scope and spirit of the invention. Accordingly, the protection sought herein is as set forth in the claims below.

The Invention claimed is:

1. An apparatus, comprising:
a roller for modifying a position of a print medium relative to a print head, said roller comprising an exterior lining, said lining comprising a plurality of particles for providing traction between said roller and said print medium.

2. The apparatus of claim 1, wherein said roller applies force to provide contact between said print medium and a film towards said print head.

3. The apparatus of claim 2, wherein said print head is capable of providing thermal energy for transferring print material from said film upon said print medium.

4. The apparatus of claim 1, wherein said roller being capable of moving said print medium in a plurality of directions for applying print material from a plurality of films.

5. The apparatus of claim 1, wherein said print medium is a paper product.

6. The apparatus of claim 1, wherein said print head further comprises a plurality of components capable of delivering thermal energy at a predetermined area on said film.

7. The apparatus of claim 6, wherein said components are spaced apart at an arrangement of at least one of 300 dots per inch, 600 dots per inch, 900 dots per inch, 1200 dots per inch, 1500 dots per inch, 1800 dots per inch, 2100 dots per inch, 2400 dots per inch, 2800 dots per inch, and 32 dots per inch.

8. The apparatus of claim 6, wherein said components further comprise a concave surface to substantially correlate to a curvature of said roller.

9. The apparatus of claim 6, wherein said components further comprise a flat surface to substantially correlate to at least a portion of said curvature of said roller.

10. An apparatus, comprising:
a roller for providing a force upon a print medium, said force being used to provide contact between said paper and a film, said roller also adapted for modifying a position of said print medium relative to a thermal print head, said roller comprising an exterior lining, said lining comprising a plurality of particles for providing traction between said roller and said print medium.

11. The apparatus of claim 6, wherein said roller being capable of moving said print medium in a plurality of directions for applying print material from a plurality of films.

12. A printing device, comprising:
a print head unit for delivering a thermal gradient; and
a roller for providing movement of a print medium, said roller also to provide a force upon said print medium, said force being used to provide contact between said paper and a film in a direction towards said print head unit for applying said thermal gradient upon said film, said roller comprising an exterior lining, said lining comprising a plurality of particles for providing traction between said roller and said print medium.

13. The printing device of claim 12, wherein said printing device is a dye-diffusion printer.

14. The printing device of claim 12, wherein said printing device further comprises a paper guide for guiding said print medium at least through a portion of said printing device.

15. The printing device of claim 12, wherein said printing device further comprises a rotation center for promoting rotation of said roller.

16. The printing device of claim 12, wherein said printing device further comprises a controller to provide control of at least one of said roller and said print head unit.

17. The printing device of claim 12, wherein said printing device further comprises a circuit for controlling an electrical signal for operation of said print head unit.

18. The printing device of claim 12, wherein said printing device further comprises a heat sink for sinking thermal energy.

19. The printing device of claim 12, wherein said print head unit further comprises a plurality of print heads capable of delivering thermal energy at a predetermined area on said film.

20. The printing device of claim 19, wherein said print heads are spaced apart at an arrangement of at least one of 300 dots per inch, 600 dots per inch, 900 dots per inch, 1200 dots per inch, 1500 dots per inch, 1800 dots per inch, 2100 dots per inch, 2400 dots per inch, 2800 dots per inch, and 32 dots per inch.

21. The printing device of claim 19, wherein said print heads further comprise a concave surface to substantially correlate to a curvature of said roller.

22. The printing device of claim 19, wherein said print heads further comprise a flat surface to substantially correlate to at least a portion of said curvature of said roller.

23. A system, comprising:
a data supply unit for providing print data; and
a printing device for printing said print data, said printing device comprising:
a print head unit for delivering a thermal gradient; and
a roller for providing movement of a print medium, said roller also to provide a force upon said print medium, said force being used to provide contact between said paper and a film in a direction towards said print head unit for applying said thermal gradient upon said film, said roller comprising an exterior lining, said lining comprising a plurality of particles for providing traction between said roller and said print medium.

24. The system of claim 19, wherein said data supply unit is at least one of a computer system and a data memory device.

25. The system of claim 12, wherein said print head unit further comprises a plurality of print heads capable of delivering thermal energy at a predetermined area on said film.

26. The system of claim 19, wherein said print heads further comprise a concave surface to substantially correlate to a curvature of said roller.

27. The system of claim 19, wherein said print heads further comprise a flat surface to substantially correlate to at least a portion of said curvature of said roller.

28. An apparatus, comprising:
a roller for modifying a position of a print medium relative to a print head, said roller comprising a plurality of particles on at least a portion of the surface of said roller, said particles for providing traction between said roller and said print medium.
